(19) United States
(12) Patent Application Publication
(10) Pub. No.: US 2026/0214003 A1
(43) Pub. Date: Jul. 23, 2026

(54) TRANSFERRING CONFIGURATION INFORMATION FROM A FIRST DEVICE TO A SECOND DEVICE BASED ON THE STATUS OF THE FIRST DEVICE

(71) Applicant: Microchip Technology Incorporated, Chandler, AZ (US)

(72) Inventors: Tik Man Lee, Chandler, AZ (US); Andy Wah Lam, Gilbert, AZ (US); Chi Lung Wong, Gilbert, AZ (US)

(73) Assignee: Microchip Technology Incorporated, Chandler, AZ (US)

(21) Appl. No.: 19/076,169

(22) Filed: Mar. 11, 2025

Related U.S. Application Data
(60) Provisional application No. 63/748,794, filed on Jan. 23, 2025.

(51) Int. Cl. H04L 41/084; G06F 8/65; G06F 8/71

(52) U.S. Cl. CPC H04L 41/0846; G06F 8/65; G06F 8/71

(57) ABSTRACT

A system, and method for automatically updating configuration or software information on a device without a connection to a central server are disclosed. A first device may include a memory of the first device to store a first configuration. The first device may also include a timer to indicate an age of the first configuration stored in the memory. The first device may further include a control circuit of the first device. The control circuit may be configured to determine, based on the age of the first configuration, that the first device has golden unit status and broadcast a status that the first device is a golden unit. The control circuit may additionally be configured to establish a communication channel between the first device and a second device. The control circuit may further be configured to transfer the first configuration from the first device to the second device.

### PRIORITY

This application claims priority to U.S. Provisional Patent Application No. 63/748,794 filed Jan. 23, 2025, the contents of which are hereby incorporated in their entirety.

### TECHNICAL FIELD

The present disclosure relates to updating configuration or software information on a device, and, in particular, to a system to automatically update configuration or software information on a device without a connection to a central server.

### BACKGROUND

The European Union (EU) Cyber Resilience Act (CRA) mandates that manufacturers provide timely and free updates for their products with digital elements throughout their lifecycle. These updates must be provided to users free of charge for a minimum of five years to ensure that all users can maintain the security of their devices. The update mechanisms should be user-friendly and easily accessible and implement a remote mandatory update of all products to apply security patches.

One mechanism for updating products in compliance with the EU CRA is the use of over-the-air (OTA) updates. OTA updates allow devices to receive software updates directly from a central server via a wireless connection, typically Wi-Fi or cellular data. These updates can include bug fixes, security patches, new features, and improved performance. The process generally involves the device connecting with a central server, checking for available updates, downloading the update package from the central server, verifying its integrity, and installing the update package. This eliminates the need for physical connections and simplifies the update process for users.

### SUMMARY OF THE INVENTION

Aspects provide systems and methods for automatically updating configuration or software information on a device without a connection to a central server. Examples of the present disclosure may include a first device. The first device may include a memory of a first device to store a first configuration. The first device may also include a timer to indicate an age of the first configuration stored in the memory of the first device. The first device may further include a control circuit of the first device. The control circuit may be configured to determine, based on the age of the first configuration, that the first device has golden unit status. The control circuit may also be configured to broadcast a status that the first device is a golden unit. The control circuit may additionally be configured to establish a communication channel between the first device and a second device. The control circuit may further be configured to transfer the first configuration from the first device to the second device.

In combination with any of the above examples, the control circuit may be configured to determine that the first device has golden unit status by determining whether the timer is above a threshold.

In combination with any of the above examples, the control circuit may be configured to determine that the first device has golden unit status using a firmware version number.

In combination with any of the above examples, the control circuit may be configured to update the timer when the age of the first configuration increases.

Alone or in combination with any of the above examples, examples of the present disclosure may include a second device. The second device may include a memory to store a first configuration of a second device. The second device may also include a timer to indicate an age of the first configuration stored in the memory of the second device. The second device may further include a control circuit of the second device. The control circuit may be configured to identify a presence of a first device broadcasting a status as a golden unit. The control circuit may also be configured to establish a communication channel between the first device and the second device. The control circuit may additionally be configured to copy an updated configuration from the first device to the memory of the second device. The control circuit may further be configured to execute the updated configuration.

In combination with any of the above examples, the control circuit may be configured to receive an age of the updated configuration from the first device.

In combination with any of the above examples, the control circuit may be configured to calculate a difference between an age of the updated configuration and the age of the first configuration stored in the memory. The control circuit may also be configured to determine that the first configuration is to be updated when the difference is above a threshold.

In combination with any of the above examples, the control circuit may be configured to identify that the updated configuration is incomplete. The control circuit may also be configured to transfer a remaining amount of the updated configuration from a third device.

In combination with any of the above examples, the control circuit may be configured to update the timer based on an age of the updated configuration.

In combination with any of the above examples, the control circuit may be configured to verify that the updated configuration is complete.

Alone or in combination with any of the above examples, examples of the present disclosure may include a method executable by a first device. The method may include storing a first configuration in a memory of the first device. The method may also include indicating an age of the first configuration stored in the memory of the first device. The method may additionally include determining, based on the age of the first configuration, that the first device has golden unit status. The method may include broadcasting a status that the first device is a golden unit. The method may also include establishing a communication channel between the first device and a second device. The method may further include transferring the first configuration from the first device to the second device.

In combination with any of the above examples, determining that the first device has golden unit may include determining whether the age of the first configuration is above a threshold.

In combination with any of the above examples, determining that the first device has golden unit may include using a firmware version number.

In combination with any of the above examples, the method may include updating the timer when the age of the first configuration increases.

Alone or in combination with any of the above examples, examples of the present disclosure may include a method executable by a second device. The method may include storing a first configuration in a memory of the second device. The method may also include indicating an age of the first configuration stored in the memory of the second device. The method may additionally include identifying a presence of a first device broadcasting a status as a golden unit. The method may include establishing a communication channel between the first device and the a second device. The method may also include copying an updated configuration from the first device to the memory of the second device. The method may further include executing the updated configuration.

In combination with any of the above examples, the method may include receiving an age of the updated configuration from the first device.

In combination with any of the above examples, the method may include calculating a difference between an age of the updated configuration and the age of the first configuration stored in the memory. The method may also include determining that the first configuration is to be updated when the difference is above a threshold.

In combination with any of the above examples, the method may include identifying that the updated configuration is incomplete. The method may also include transferring a remaining amount of the updated configuration from a third device.

In combination with any of the above examples, the method may include updating the timer based on an age of the updated configuration.

In combination with any of the above examples, the method may include verifying that the updated configuration is complete.

### BRIEF DESCRIPTION OF THE DRAWINGS

The figures illustrate examples of systems and methods for automatically updating configuration or software information on a device without a connection to a central server.

FIGS. 1A and 1B illustrate a system for automatically updating configuration or software information on a device without a connection to a central server, according to examples of the present disclosure;

FIG. 2 illustrates a system for automatically updating configuration or software information on a device without a connection to a central server, according to examples of the present disclosure;

FIG. 3 illustrates a method performed by a golden unit to automatically update configuration or software information on a device without a connection to a central server, according to examples of the present disclosure; and

FIG. 4 illustrates a method performed by a device to automatically update configuration or software information on the device without a connection to a central server, according to examples of the present disclosure.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect of the invention, a system for automatically updating configuration or software information on a device without a connection to a central server is provided. While over-the-air (OTA) updates may be used to update configuration or software information on a device, some devices may lack a connection to a central server to receive the OTA updates. Therefore, the disclosed systems and methods may allow one product having more up-to-date configuration or software information to upgrade another product having out-of-date configuration or software information. The updates may occur after the product is manufactured, such as during transportation, during storage, or out in the field. By using the disclosed systems and methods, the process for updating configuration or software information on a device may be improved by speeding up the process, eliminating the need for a connection to a central server, reduce production time, allow the update of product configuration or firmware version after a device is manufactured, and provide a mechanism for complying with the European Union (EU) Cyber Resilience Act (CRA).

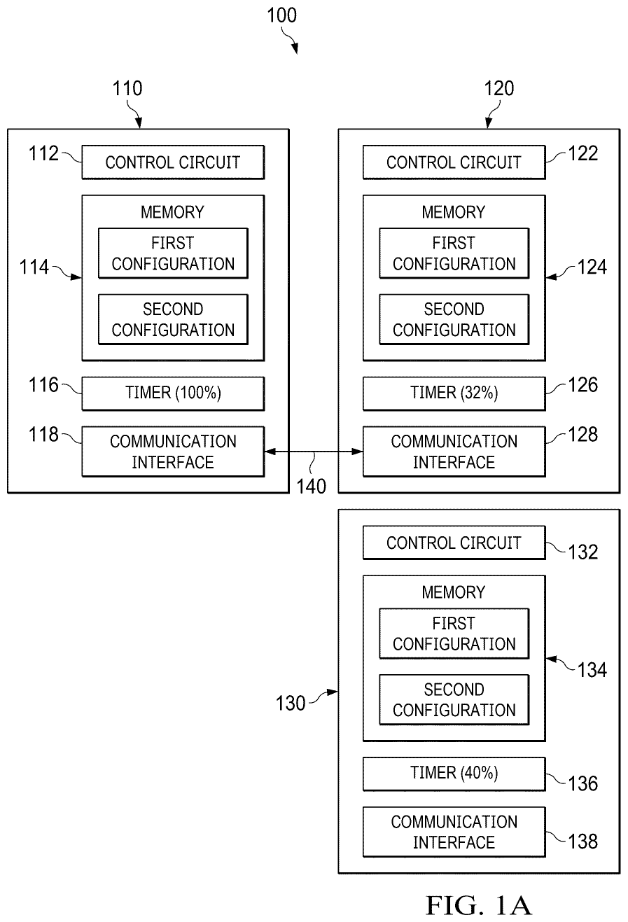

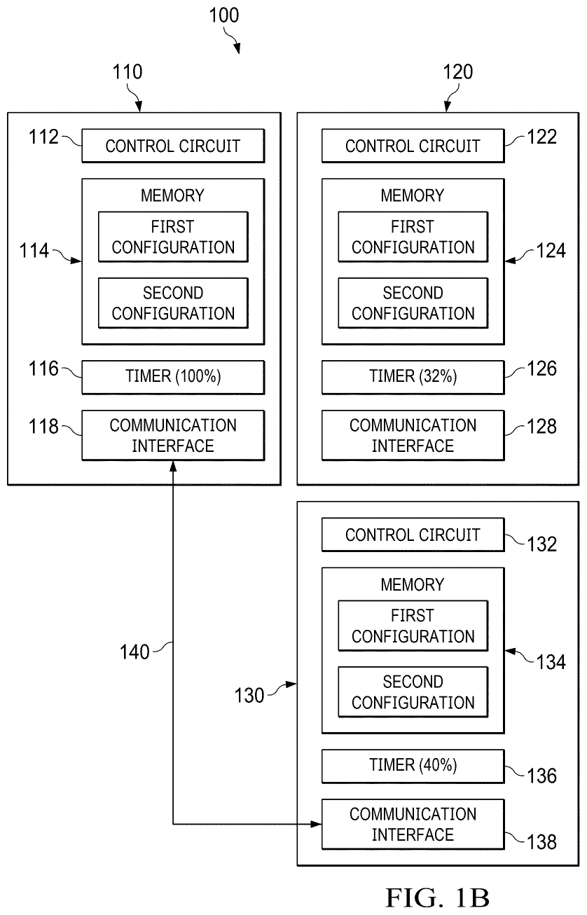

FIGS. 1A and 1B illustrate a system for automatically updating configuration or software information on a device without a connection to a central server, according to examples of the present disclosure. System 100 includes unit 110, unit 120, and unit 130. Units 110, 120, and 130 are separate physical devices and may be the same type or similar types of devices (e.g., electronic devices such as cameras or vehicles such as cars or trucks). At the time of the update process described herein, units 110, 120, and 130 are not communicatively coupled to the central server. Therefore, unless units 110, 120, and 130 use the disclosed system and methods for automatically updating configuration information, units 110, 120, and 130 will not receive configuration updates while units 110, 120, and 130 are in use (e.g., when a vehicle is away from a depot or distribution center). This may allow units 110, 120, and 130 to be updated after manufacturing, such as during transportation, during storage, or out in the field.

Units 110, 120, and 130 may include control circuits 112, 122, and 132, respectively. Control circuits 112, 122, and 132 may be implemented by instructions for execution by a processor, analog circuitry, digital circuitry, control logic, digital logic circuits programmed through hardware description language, application specific integrated circuits (ASIC), field programmable gate arrays (FPGA), programmable logic devices (PLD), or any suitable combination thereof, whether in a unitary device or spread over several devices. Control circuits 112, 122, and 132 may be implemented by instructions for execution by a processor through, for example, a function, application programming interface (API) call, script, program, compiled code, interpreted code, binary, executable, executable file, firmware, object file, container, assembly code, or object. For example, control circuits 112, 122, and 132 may be implemented by instructions stored in a non-transitory medium such as a memory that, when loaded and executed by a processor such as a central processing unit (CPU) (or any other suitable process), cause the functionality of control circuits 112, 122, and 132 described herein.

Units 110, 120, and 130 may also include memory 114, 124, and 134, respectively. Memory 114, 124, and 134 may include one or more type of memory device to store firmware, software patches, configuration information, or any combination thereof. For example, memory 114, 124, and 134 may be read-only memory (ROM), random access memory (RAM, SRAM, DRAM), electrically erasable programmable read-only memory (EEPROM), a PCMCIA card, flash memory, magnetic storage, opto-magnetic storage, hardware registers, and/or any suitable selection or array of volatile or non-volatile memory. Memory 114, 124, and 134 may store a copy of the firmware, software patches, configuration information, or any combination thereof installed on units 110, 120, and 130, respectively. For example, memory 114, 124, and 134 may be partitioned such that a first configuration is stored in a primary partition and a second configuration is stored in a secondary partition. The first configuration may be newer than the second configuration.

Units 110, 120, and 130 may further include timers 116, 126, and 136, respectively. Timers 116, 126, and 136 may indicate an age of the first configuration on unit 110, 120, and 130, respectively. For example, timer 116 may have a value of 100% to indicate that the first configuration in memory 114 of unit 110 is the most up-to-date configuration. Timer 126 may have a value of 32% to indicate that the first configuration in memory 124 of unit 120 is out-of-date. Timer 136 may have a value of 40% to indicate that the first configuration in memory 134 of unit 130 also is out-of-date. However, the first configuration in memory 134 of unit 130 is newer than the first configuration in memory 124 of unit 120 as indicated by timer 136 having a greater value that timer 126. The value of timers 116, 126, and 136 may be set by the manufacturer of units 110, 120, and 130 and may be based on a firmware version number, a time elapsed since the first configuration was last updated, or any other suitable method of indicating the age of the first configuration on unit 110, 120, and 130, respectively. For example, the value of timers 116, 126, and 136 may be based on the manufacturer's firmware update policy. If the manufacturer plans to update firmware once every five years, the value of timers 116, 126, and 136 may continuously decrease based on a five year interval (e.g., timer 116 has a value of 100% on the day the firmware is released and installed on unit 110, a value of 80% one year after the firmware is released, a value of 40% three years after the firmware is released, and a value of 0% five years after the firmware is released). Timers 116, 126, and 136 may continuously decrease based on the manufacturer's policy until the configuration information on units 110, 120, and 130 is updated. After the configuration information is updated, the timer may be reset as described below.

Timers 116, 126, and 136 may also be used by units 110, 120, and 130, respectively to identify which of the first or the second configuration to run on units 110, 120, and 130. For example, when timer 116 indicates a firmware version number, control circuit 112 of unit 110 may compare the firmware version number of the first configuration to the firmware version number of the second configuration to identify which configuration is the latest and run that configuration.

Unit 110 may determine if unit 110 is a “golden unit.” Whether a unit is a golden unit may be based on the value of timer 116. For example, in FIG. 1A, unit 110 may be considered a “golden unit” because unit 110 has the most up-to-date configuration (as indicated by timer 116 having a value of 100%). Units 120 and 130 may also determine if they are golden units. For example, in FIG. 1A, unit 120 may not be a golden unit because timer 126 is 32% indicating that the first configuration of unit 120 is out-of-date. Unit 130 may also not be a golden unit because timer 136 is 40% indicating that the first configuration of unit 130 is also out-of-date (but not as old as the first configuration on unit 120).

Unit 110 may broadcast its status as a golden unit via communication interface 118. Unit 110 may also broadcast the value of timer 116. When unit 110 is in communication range of unit 120 or unit 130, the latest version of the configuration from memory 114 on unit 110 may be transferred to unit 120 or unit 130. For example, control circuit 122 on unit 120 may recognize the presence of a golden unit (e.g., unit 110) and establish communication channel 140 between communication interface 118 and communication interface 128. Control circuit 122 may cause a copy of the first configuration stored in memory 114 to be transferred to memory 124 via communication channel 140. Communication channel 140 may use any suitable communications protocol, such as, but not limited to, a wide area network (e.g., narrowband internet of things (NB-IOT), long range wide area network (LoRaWAN)), a home wireless network (e.g., Wi-Fi, Bluetooth), a proprietary wireless technology (e.g., Sub-GHz, MiWi, Zigbee), wired network (e.g., universal serial bus (USB), Ethernet), or any combination thereof. In some examples, communication channel 140 may be a secure communication channel.

In some examples, control circuit 122 may determine whether to transfer a copy of the first configuration stored in memory 114 to memory 124 based on the difference between timer 116 and timer 126. Control circuit 122 may receive the value of timer 116 from unit 110 broadcasting the value and compare the value of timer 116 to the value of timer 126. For example, if the difference between timer 116 and timer 126 is less than a predetermined threshold, control circuit 122 may not transfer a copy of the first configuration stored in memory 114. By way of example, if timer 126 is 95% and timer 116 is 100%, control circuit 122 may determine that, even though unit 110 is a golden unit, unit 120 is sufficiently up-to-date and not transfer a copy of the first configuration stored in memory 114. The predetermined threshold may be selected by a manufacturer based on how often units 110, 120, and 130 may be updated.

The first configuration from memory 114 may be transferred to the second configuration position in memory 124. After the first configuration from memory 114 is transferred to memory 124, control circuit 122 may install the first configuration on unit 120 to update unit 120. At this point, control circuit 122 may switch the second configuration position in memory 124 to be the first configuration positing in memory 124 such that the first configuration in memory 124 contains the most up-to-date configuration information. After unit 120 is updated, timer 126 may be reset to 100% (as shown in FIG. 1B) to indicate that unit 120 has the most up-to-date configuration. Unit 120 may then determine that it is a golden unit and broadcast its status as a golden unit via communication interface 128. In examples where the timer of the golden unit transferring the configuration information is not 100%, the timer of the unit receiving the updated configuration information may be set to the same value as the timer of the golden unit.

As shown in FIG. 1B, after unit 120 is updated, system 100 may include two golden units, unit 110 and 120. When either unit 110 or unit 120 comes in communication range with unit 130, unit 110 or unit 120 may update unit 130 using the same process unit 110 used to update unit 120.

Referencing an example where unit 110 is transferring an updated configuration to unit 130, in the event that transfer of the first configuration from memory 114 to memory 134 is interrupted (for example if unit 110 and unit 130 are no longer in communication range), a partial copy of the first configuration may be saved in memory 134. The transfer of the first configuration may restart when communication channel 140 is restored. In some examples, the transfer of the first configuration may be completed from a different golden unit. For example, a first half of the first configuration may transfer from memory 114 to memory 134. If communication channel 140 is disconnected and not restored, unit 120 and unit 130 may come into communication range and establish a communication channel and the second half of the first configuration may be transferred from memory 124 to memory 134. After the transfer is complete, control circuit 132 on unit 130 may install the first configuration on unit 130 to update unit 130. After unit 130 is updated, timer 136 may be reset to 100% to indicate that unit 130 has the most up-to-date configuration.

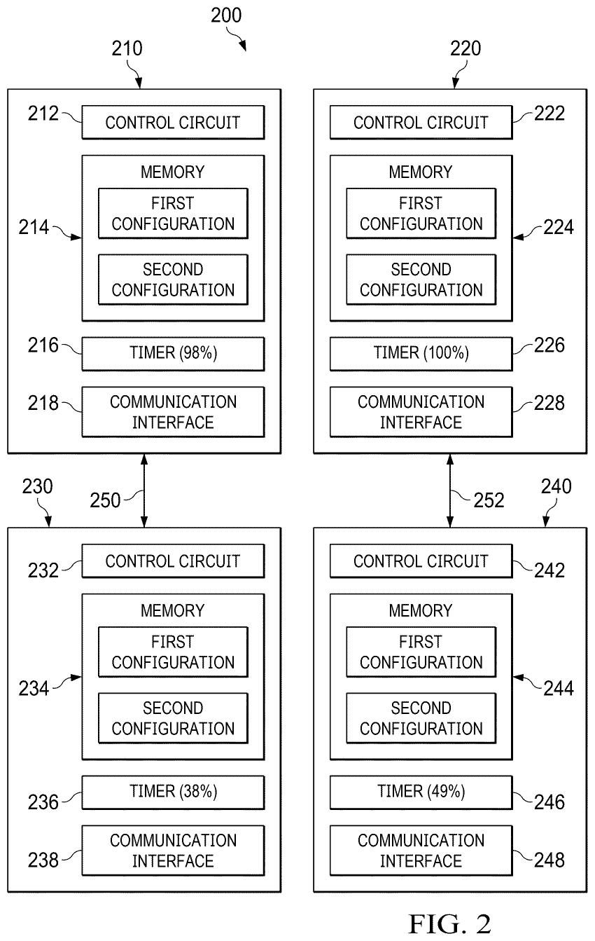

FIG. 2 illustrates a system for automatically updating configuration or software information on a device without a connection to a central server, according to examples of the present disclosure. System 200 includes unit 210, unit 220, unit 230, and unit 240. Units 210, 220, 230, and 240 are separate physical devices and may be the same type or similar types of devices (e.g., electronic devices such as cameras or vehicles such as cars or trucks). At the time of the update process described herein, units 210, 220, 230, and 240 are not communicatively coupled to the central server and may use the disclosed update process described to obtain updates after manufacturing, such as during transportation, during storage, or out in the field. Units 210, 220, 230, and 240 may include control circuits 212, 222, 232, and 242, respectively. Control circuits 212, 222, 232, and 242 may be similar to control circuits 112, 122, and 132 shown in FIGS. 1A and 1B. Units 210, 220, 230, and 240 may also include memory 214, 224, 234, and 244, respectively. Memory 214, 224, 234, and 244 may be similar to memory 114, 124, and 134 shown in FIGS. 1A and 1B. Memory 214, 224, 234, and 244 may store a copy of the firmware, software patches, configuration information, or any combination thereof installed on units 210, 220, 230, and 240, respectively.

Units 210, 220, 230, and 240 may further include timers 216, 226, 236, and 246, respectively. Timers 216, 226, 236, and 246 may be similar to timers 116, 126, and 136 shown in FIGS. 1A and 1B. Timers 216, 226, 236, and 246 may indicate the age of the first configuration on unit 210, 220, 230, and 240, respectively.

Unit 220 may be a golden unit because unit 220 has the most up-to-date configuration (as indicated by timer 226 having a value of 100%). Unit 220 may be a golden unit because unit 220 may have the most recent configuration information. Additionally, unit 210 may also be a golden unit because timer 216 may be above a predetermined threshold indicating that the first configuration on unit 210 is sufficiently up-to-date that other units (e.g., unit 230 or unit 240) may be updated from unit 210. For example, any unit with a timer above a predetermined threshold (e.g., above 90%, above 80%, above 50%) may serve as a golden unit. Alternatively, or in addition, any unit with a higher timer value may be a golden unit as to another unit with a lower timer value. Referring to the example shown in FIG. 2, in some examples, unit 240 may be a golden unit as to unit 230 because timer 246 is greater than timer 236. However, unit 240 may not be a golden unit as to unit 210 or unit 220 because timer 246 is less than timer 216 and timer 226. Units 210 and 220 may broadcast their status as golden units such that they are discoverable by other devices in communication range of units 210 and 220.

Unit 230 may identify unit 210 as a golden unit and may initiate a transfer of an updated configuration to unit 230 using communication channel 250 between communication interface 218 and communication interface 238. Unit 220 may transfer the updated configuration to unit 240 using communication channel 252. Communication channels 240 and 242 may be similar to communication channel 140 shown in FIGS. 1A and 1B. While FIG. 2 illustrates a one-to-one connection between units 210 and 230 and units 220 and 240, in some examples, system 200 may use a one-to-may connection (e.g., unit 210 may connect to both units 230 and 240 or unit 220 may connect to both units 230 and 240).

As time passes and new versions of the configurations of units 210 and 220 are released, timers 216 and 226 may decrease such that the configurations of units 210 and 220 are no longer the most up-to-date and units 210 and 220 may no longer be golden units. Units 210 and 220 may become golden units again after connecting to another golden unit to update the configuration of units 210 and 220. For example, the value of timers 216 and 226 may continuously decrease based on the manufacturer's policy until the configuration information on units 210 and 220 is updated. After the configuration information is updated, the timer may be reset.

An example implementation of system 100 or system 200 may include a system having multiple electronic components (e.g., cameras). The electronic components may be able to communicate with one another (e.g., using any suitable communication protocol such as Wi-Fi or Bluetooth), but are not typically connected to a central server. When the manufacturer of the electronic components releases a new configuration version, a first electronic component may be updated with the latest configuration (and become a golden unit) and the other electronic components may be updated when the other electronic components come in communication range with the first electronic component. As an example, a retailer may have the electronic components in a store or warehouse. The retailer may update the first electronic component and, over time, the other electronic components may be updated as the configuration passes from the first electronic component to the other electronic components using the process described with respect to FIGS. 1A, 1B, and 2.

As another example implementation of system 100 or system 200, a system may include multiple trucks. The trucks may be able to communicate with one another (e.g., using any suitable communication protocol such as Wi-Fi or Bluetooth), but are not typically connected to a central server. When the manufacturer or operator of the trucks releases a new configuration version, a first truck may be updated with the latest configuration, becoming a golden unit, and other trucks may be updated when the other trucks come in communication range with the first truck. As an example, an operator may have many trucks in its fleet. The operator may update a first truck and, over time, the other trucks may be updated as the configuration passes from the first truck to other trucks using the process described with respect to FIGS. 1A, 1B, and 2. For example, the first truck may come into communication range with other trucks on the road or at a distribution center.

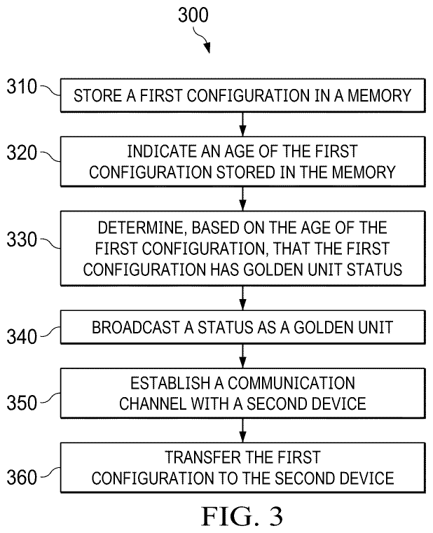

FIG. 3 illustrates a method performed by a golden unit to automatically update configuration or software information on a device without a connection to a central server, according to examples of the present disclosure. Method 300 may be implemented using an ionization smoke detector, in combination with a control circuit, using a central processing unit (CPU), a general purpose processor, a specific purpose processor, a microcontroller, a programmable logic controller (PLC), a digital signal processor (DSP), an application specific integrated circuit (ASIC), a field-programmable gate array (FPGA) or other programmable logic device, core independent peripheral (CIP), discrete gate or transistor logic, discrete hardware components, other programmable device, or any combination thereof designed to perform the functions disclosed herein, in combination with a processor, or any other system operable to implement method 300. Although examples have been described above, other variations and examples may be made from this disclosure without departing from the spirit and scope of these disclosed examples.

Method 300 may begin at block 310 where a first configuration may be stored in a memory of a first device. The first device may be a golden unit and may have up-to-date configuration information. The memory may store a copy of the firmware, software patches, configuration information, or any combination thereof installed on the device. The memory may be partitioned such that a first configuration is stored in a primary partition and a second configuration is stored in a secondary partition. The first configuration may be newer than the second configuration.

At block 320, an age of the first configuration stored in the memory of the first device may be indicated in a timer of the first device. For example, the timer may have a value of 100% to indicate that the first configuration in the memory is the most up-to-date configuration. The value of the timer may be based on a firmware version number, a time elapsed since the first configuration was last updated, or any other suitable method of indicating the age of the first configuration in the memory. The value of the timer may also include a firmware version number. As the age of the first configuration increases, the timer may be updated to reflect the increasing age of the first configuration.

At block 330, based on the age of the first configuration, a determination may be made that the first device has golden unit status. For example, a control circuit on the first device may determine that the first device is a golden unit. Whether the first device has golden unit status may be based on the value of the timer. For example, a first device may be considered to have golden unit status because the timer has a value of 100%. Additionally, or alternatively, the determination may be based on whether the age of the first configuration is above a threshold. For example, whether the timer is above a predetermined threshold (e.g., above 90%, above 80%, above 50%).

At block 340, a status of the first device as a golden unit may be broadcast. For example, the first device containing the first configuration in memory may broadcast its status as a golden unit via a communication interface on the device. Additionally, the first device may broadcast the value of the timer of the first device.

At block 350, a communication channel may be established between the first device and a second device. The communication channel may be established when the first device containing the first configuration and the second device are within communication range.

At block 360, the first configuration may be transferred from the first device to the second device. The second device may contain a control circuit that initiates a transfer of the first configuration from the first device broadcasting that it has golden unit status, and, in response, a control circuit on the first device broadcasting that it has golden unit status may transfer the first configuration.

Although FIG. 3 discloses a particular number of operations related to method 300, method 300 may be executed with greater or fewer operations than those depicted in FIG. 3. In addition, although FIG. 3 discloses a certain order of operations to be taken with respect to method 300, the operations comprising method 300 may be completed in any suitable order.

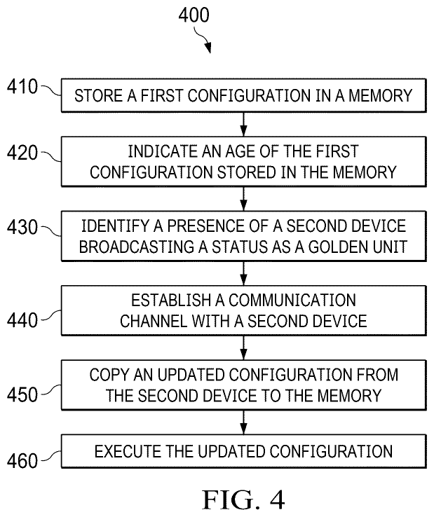

FIG. 4 illustrates a method performed by a device to automatically update configuration or software information on the device without a connection to a central server, according to examples of the present disclosure. Method 400 may be implemented using an ionization smoke detector, in combination with a control circuit, using a central processing unit (CPU), a general purpose processor, a specific purpose processor, a microcontroller, a programmable logic controller (PLC), a digital signal processor (DSP), an application specific integrated circuit (ASIC), a field-programmable gate array (FPGA) or other programmable logic device, core independent peripheral (CIP), discrete gate or transistor logic, discrete hardware components, other programmable device, or any combination thereof designed to perform the functions disclosed herein, in combination with a processor, or any other system operable to implement method 400. Although examples have been described above, other variations and examples may be made from this disclosure without departing from the spirit and scope of these disclosed examples.

Method 400 may begin at block 410 where a first configuration may be stored in a memory of a second device. The second device may be deployed in the field and not have a connection to a central server to receive updated configuration information. The memory may store a copy of the firmware, software patches, configuration information, or any combination thereof installed on the device. The memory may be partitioned such that a first configuration is stored in a primary partition and a second configuration is stored in a secondary partition.

At block 420, an age of the first configuration stored in the memory of the second device may be indicated in a timer of the second device. For example, the timer may have a value of 40% to indicate that the first configuration in the memory is not the most up-to-date configuration. The value of the timer may be based on a firmware version number, a time elapsed since the first configuration was last updated, or any other suitable method of indicating the age of the first configuration in the memory. The value of the timer may also include a firmware version number. As the age of the first configuration increases, the timer may be updated to reflect the increasing age of the first configuration.

At block 430, a presence of a first device broadcasting a status as a golden unit may be identified. When the second device comes within communication range of a first device broadcasting its status as a golden unit, the second device may determine that it can update the first configuration from the first device.

At block 440, a communication channel may be established between the second device and the first device. The communication channel may be established when the first device containing the first configuration and the second device are within communication range. The first device may be a golden unit (identified at block 430).

At block 450, an updated configuration may be copied from the first device to the memory of the second device. The second device may contain a control circuit that initiates a transfer of the updated configuration from the first device broadcasting that it has golden unit status. The updated configuration may be copied to a second partition in the memory. The second device may also receive an age of the updated configuration from the first device. In some examples, the second device may calculate a difference between an age of the updated configuration and the age of the first configuration (from block 410). The second device may determine that the first configuration should be updated based on whether the difference is above a threshold.

When copying the updated configuration from the first device, the second device may identify whether the updated configuration is incomplete. For example, the updated configuration may be incomplete when the communication channel is interrupted. The second device may transfer a remaining amount of the updated configuration from a third device when the second device comes in communication range of a third device having golden unit status.

At block 460, the updated configuration may be executed by the second device. Before executing the updated configuration, the second device may verify that the updated configuration is complete. The second device may also update the timer based on the age of the updated configuration (e.g., the second device may update the timer of the second device to match the value of the timer of the first device). After the updated configuration is executed, the updated configuration may become the first configuration.

Although FIG. 4 discloses a particular number of operations related to method 400, method 400 may be executed with greater or fewer operations than those depicted in FIG. 4. In addition, although FIG. 4 discloses a certain order of operations to be taken with respect to method 400, the operations comprising method 400 may be completed in any suitable order.

While the examples described above reference updating configuration on a device, the described systems and methods may be used to update firmware, install software patches, or any other information that may be updated on a device.

Although examples have been described above, other variations and examples may be made from this disclosure without departing from the spirit and scope of these disclosed examples.

1. A first device, comprising:
a memory of a first device to store a first configuration;
a timer to indicate an age of the first configuration stored in the memory of the first device; and
a control circuit of the first device configured to:
determine, based on the age of the first configuration, that the first device has golden unit status;
broadcast a status that the first device is a golden unit;
establish a communication channel between the first device and a second device; and
transfer the first configuration from the first device to the second device.

2. The first device of claim 1, wherein the control circuit is configured to determine that the first device has golden unit status by determining whether the timer is above a threshold.

3. The first device of claim 1, wherein the control circuit is configured to determine that the first device has golden unit status using a firmware version number.

4. The first device of claim 1, wherein the control circuit is configured to update the timer when the age of the first configuration increases.

5. A second device, comprising:
a memory to store a first configuration of a second device;
a timer to indicate an age of the first configuration stored in the memory of the second device; and
a control circuit of the second device configured to:
identify a presence of a first device broadcasting a status as a golden unit;
establish a communication channel between the first device and the second device;
copy an updated configuration from the first device to the memory of the second device; and
execute the updated configuration.

6. The second device of claim 5, wherein the control circuit is configured to receive an age of the updated configuration from the first device.

7. The second device of claim 5, wherein the control circuit is configured to:
calculate a difference between an age of the updated configuration and the age of the first configuration stored in the memory; and
determine that the first configuration is to be updated when the difference is above a threshold.

8. The second device of claim 5, wherein the control circuit is configured to:
identify that the updated configuration is incomplete; and
transfer a remaining amount of the updated configuration from a third device.

9. The second device of claim 5, wherein the control circuit is configured to update the timer based on an age of the updated configuration.

10. The second device of claim 5, wherein the control circuit is configured to verify that the updated configuration is complete.

11. A method executable by a first device, the method comprising:
storing a first configuration in a memory of a first device;
indicating an age of the first configuration stored in the memory of the first device;
determining, based on the age of the first configuration, that the first device has golden unit status;
broadcasting a status that the first device is a golden unit;
establishing a communication channel between the first device and a second device; and
transferring the first configuration from the first device to the second device.

12. The method of claim 11, wherein determining that the first device has golden unit includes determining whether the age of the first configuration is above a threshold.

13. The method of claim 11, wherein determining that the first device has golden unit includes using a firmware version number.

14. The method of claim 11, comprising updating the timer when the age of the first configuration increases.

15. A method executable by a second device, the method comprising:
storing a first configuration in a memory of a second device;
indicating an age of the first configuration stored in the memory of the second device;
identifying a presence of a first device broadcasting a status as a golden unit;
establishing a communication channel between the first device and the second device;
copying an updated configuration from the first device to the memory of the second device; and
executing the updated configuration.

16. The method of claim 15, comprising receiving an age of the updated configuration from the first device.

17. The method of claim 15, comprising:
calculating a difference between an age of the updated configuration and the age of the first configuration stored in the memory; and
determining that the first configuration is to be updated when the difference is above a threshold.

18. The method of claim 15, comprising:
identifying that the updated configuration is incomplete; and
transferring a remaining amount of the updated configuration from a third device.

19. The method of claim 15, comprising updating the timer based on an age of the updated configuration.

20. The method of claim 15, comprising verifying that the updated configuration is complete.
